(19) United States
(12) Patent Application Publication
(10) Pub. No.: US 2003/0025277 A1
(43) Pub. Date: Feb. 6, 2003

(54) High Pressure seal

(76) Inventors: Robert W. Torres, Orange, CA (US); Phil M. Oshita, Santa Ana, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/919,326

(22) Filed: Jul. 31, 2001

(51) Int. Cl. F16J 3/00

(52) U.S. Cl. 277/628

(57) ABSTRACT

A sealing assembly for sealing a cavity. The sealing assembly includes a sleeve and a molded skirt. A cable is threaded through the sleeve and the cable and sealing assembly are inserted into the cavity. The sealing assembly skirt has a sealing surface that has the same shape as the interior surface of the cavity. This reduces the likelihood of the skirt wrinkling and creating leak paths when it is in sealing contact with the interior surface of the cavity. One preferred embodiment of the sealing assembly can be used to seal an electrical connector.

### FIELD OF THE INVENTION

This invention relates generally to electrical connectors and, more specifically, to high pressure seals used in electrical connectors.

### BACKGROUND OF THE INVENTION

Electrical connectors for connecting one electrical component to another are used in a variety of applications. Irrespective of the application, it is important for electrical connectors to be free from short circuiting and arcing. Electrical connectors can fail because conductive fluids, such as salt laden air, create a conductive path between adjacent cables and/or contacts. The ability of these conductive fluids to cause electrical connector failure is particularly problematic in applications where there are frequent changes in the air pressure surrounding a connector. If the air pressure decreases, any fluids or gases within the connector exhaust to stabilize the internal and external pressures. If air pressure increases again, the pressure differential between the inside of the connector and its exterior can cause contaminants to be drawn into the interior of the connector. This problem is particularly severe in airplanes that take off and land near the ocean. When a connector is in a salt air environment, frequent changes in air pressure can cause connector failure unless the exposed connector contacts are sealed from the external environment.

A number of electrical connectors that reduce the likelihood of failure due to arcing or short circuiting are known in the prior art. U.S. Pat. No. 3,792,416 to Moulin describes a type of electrical connector that prevents short circuiting or arcing due to conductive fluids by individually sealing each contact in the connector. This electrical connector establishes contacts between wires using a pin contact mated with a socket contact. The pin contacts are housed in a pin connector body and the socket contacts are housed in a socket connector body. Each contact is shielded from the environment using a combination of wire and interfacial seals. Wire seals are used to create a seal where each of the wires enters the rear face of the pin or socket connector body. Interfacial seals are used to seal the exposed contacts where the pin and socket connector bodies meet. This use of wire and interfacial seals results in each contact in the connector being completely sealed from the external environment. U.S. Pat. No. 3,792,416 to Moulin is incorporated by reference in its entirety into the present disclosure.

Turning now to FIG. 1A, a well known sealing assembly 10 including a sleeve 12 and a flange 14 is illustrated. The sleeve has a longitudinal axis 16 and the flange forms a uniform ring around the sleeve 12 in a plane perpendicular to the longitudinal axis 16. The sealing assembly is typically constructed from an elastomeric material that is elastic but not compressible. The sealing assembly is similar to the wire seal illustrated in FIG. 5 of U.S. Pat. No. 3,792,416 to Moulin.

Turning now to FIG. 1B in addition to FIG. 1A, a method of sealing a cylindrical cavity 18 using the prior art sealing assembly 10 is illustrated. For the sealing assembly 10 to create a seal, the diameter of its flange 14 must be greater than the diameter of cavity 18. As the sealing assembly 10 is forced into the cavity 18, the flange 14 is bent in the direction opposite to the direction of insertion. Bending of the flange 14 forms it into a cup like shape, creating a seal where the cup rim 14a contacts the cavity interior surface 20.

Turning now to FIG. 1C in addition to FIGS. 1A and 1B, it can be understood how a loss of sealing contact can result from a wrinkling of the flange 14 that can occur when the sealing assembly is inserted into the cavity. Such wrinkling in the flange 14 can occur because the flange outside circumference is greater than the internal circumference of the cavity. For example, the outside circumference of the unbent flange 14 is shown as line 30 in FIG. 1C. When the flange is bent into a cup shape as is required as the sealing assembly is inserted into the cylindrical cavity, the mouth of the resulting cup is contained within an area bounded by the internal circumference of the cavity. However, because the total length of the rim of the cup is equal to the outside circumference of the unbent flange, the rim of the cup cannot be circular. Instead, when flange 14 is bent or deformed into a cup shape, the rim of the cup is caused to wrinkle. The total length of the rim of the cup is the length of the line shown as 32 in FIG. 1C, which is the same as the length of the circumference of the unbent flange 14 represented by the line 30. The wrinkles in the flange 14 can create a leak path through the seal. A leak path is created when the gap between the flange 14 and the interior surface of the cavity 20 created by the wrinkle extends from the mouth of the cup to the point at which the flange 14 is connected to the sleeve 12. Such a wrinkle creates a leak path because, air from outside the cavity can pass into the cavity and vice versa through the gap between the flange 14 and the cavity interior surface 20 created by the wrinkle. Therefore, wrinkles resulting from the deformation of the flange 14 can prevent the creation of a perfect seal between the sealing assembly 10 and the cavity's cylindrical interior surface 18.

### SUMMARY OF THE INVENTION

In accordance with practice of the present invention, a sealing assembly is provided comprising a sleeve and a molded skirt on the sleeve. The skirt comprises an interior surface and a sealing surface. The sealing surface has substantially the same shape as the interior surface of the cavity such that the sealing surface is not substantially wrinkled when the sealing surface is in sealing contact with the inside surface of the cavity.

### BRIEF DESCRIPTION OF THE DRAWINGS

FIG. 1A is a semi-schematic cross-sectional view showing a prior art sealing assembly;

FIG. 1B is a semi-schematic cross-sectional view showing a prior art sealing assembly inserted into a cavity;

FIG. 1C is a semi-schematic cross-sectional view showing a wrinkled flange of a prior art sealing assembly inserted into a cavity;

FIG. 2 is a semi-schematic cross sectional view of one embodiment of sealing assembly provided in accordance with practice of the present invention having a sleeve and a molded skirt;

FIGS. 3A-3B are semi-schematic cross sectional views of the sealing assembly of the FIG. 2 embodiment of the present invention in combination with a wire being inserted into a cavity;

FIG. 4 is a semi-schematic cross sectional view showing another embodiment of a sealing assembly provided in accordance with practice of the present invention comprising two molded skirts;

FIG. 5A is a semi-schematic cross sectional view of mated pin and socket connector bodies showing wires and contacts including sealing assemblies provided in accordance with practice of the present invention;

FIG. 5B is a semi-schematic cross sectional view of a pin connector body;

FIG. 5C is a semi-schematic cross sectional view of a socket connector body;

FIG. 6A is a semi-schematic cross sectional view showing a pin contact;

FIG. 6B is a semi-schematic cross sectional view showing a socket contact;

FIG. 6C is a semi-schematic cross sectional view showing a wire inserted into a contact;

FIG. 7A is a semi-schematic cross sectional view showing a wire, contact and sealing assembly in accordance with practice of the present invention outside a cavity;

FIG. 7B is a semi-schematic cross sectional view showing a wire, contact and sealing assembly in accordance with practice of the present invention inside a cavity;

FIG. 7C is a semi-schematic cross sectional view showing a pin contact in a pin connector body and a socket contact in a socket connector body;

FIG. 7D is a semi-schematic cross sectional view showing a pin contact in a pin connector body, a socket contact in a socket connector body and a sealing assembly in accordance with practice of the present invention having two skirts mounted on a pin contact in the pin connector body;

FIG. 7E is a semi-schematic cross sectional view showing mated pin and socket contacts sealed by sealing assemblies in accordance with practice of the present invention;

FIG. 8 is a semi-schematic cross sectional view showing another embodiment of a sealing assembly provided in accordance with practice of the present invention including a wiping land.

### DETAILED DESCRIPTION OF THE INVENTION

Although detailed exemplary embodiments of the sealing assembly provided in accordance with practice of the present invention are disclosed herein, other suitable structures for practicing the present invention may be employed as will be apparent to persons of ordinary skill in the art. Consequently, specific structural and functional details disclosed herein are representative only; they merely describe exemplary embodiments of the sealing assembly of the present invention.

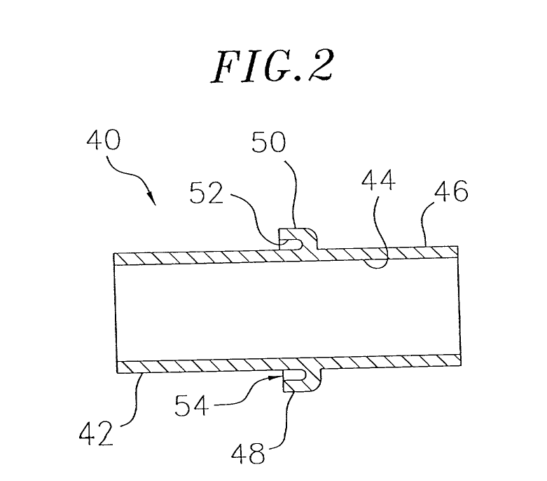

Turning to FIG. 2, one exemplary embodiment of a high pressure sealing assembly 40 provided in accordance with practice of the present invention is illustrated. The sealing assembly comprises a generally cylindrical sleeve 42, which has an interior surface 44 and an exterior surface 46. An integrally formed skirt 48 extends circumferentially around the sleeve. The skirt includes a sealing surface 50 and an interior surface 52, and is shaped such that a circumferential gap 54 is defined between the sleeve exterior surface 46 and the skirt interior surface 52. In one embodiment the sealing assembly 40 is injection molded from an elastomeric material such as a silicone or flourosilicone rubber. Preferably the materials from which the seal is typically made are elastic but are not subject to compression.

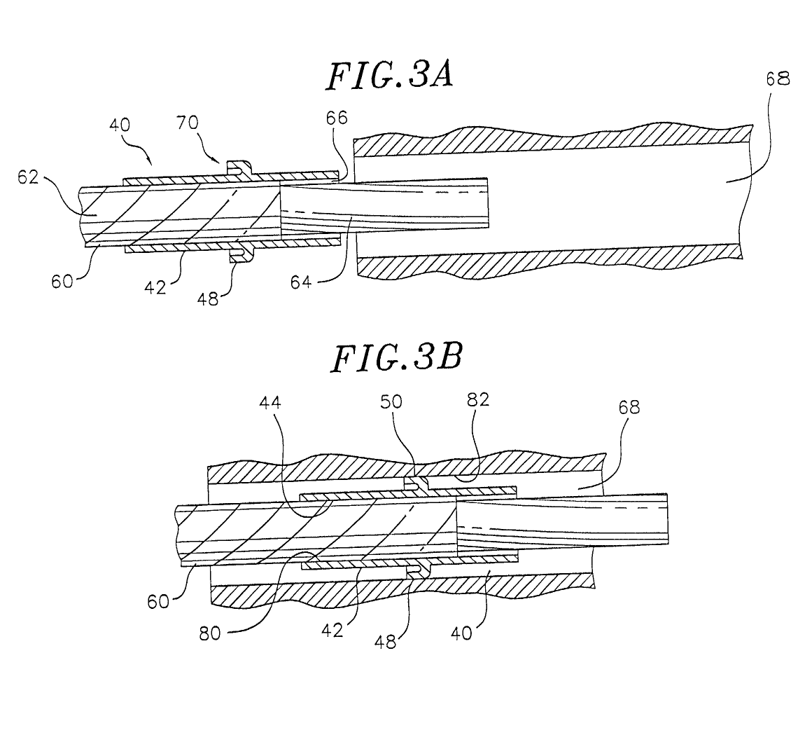

Turning to FIGS. 3A and 3B in addition to FIG. 2, the structural configuration of the high pressure sealing assembly 40 that enables it to seal an opening between a structure and a cavity can be understood. In the illustrated embodiment, the sealing assembly 40 is mounted on a wire 60 which is partially shielded with insulation 62 and which has its bare or uninsulated end 64 extending from the insertion end 66 of the generally cylindrical sealing assembly sleeve 42. A seal is created between the wire 60 and a cavity 68 when the sealing assembly 40 and associated wire 60 are forced into the cavity 68. The sealing assembly is mounted on the wire 60 in such a way that the open end 70 of the skirt faces away from the cavity 68 when the wire 60 and sealing assembly 40 are inserted into the cavity.

Referring to FIG. 3B, the shapes of the interior surface 44 of the sleeve 40 and the skirt sealing surface 50 are chosen to prevent leak paths through the seal. The sleeve interior surface 44 preferably has substantially the same shape and fits tightly around the wire exterior surface 80 to thereby provide a leak tight fit between the wire 60 and the sleeve. The skirt sealing surface 50 preferably has the same shape as the interior surface 82 of the cavity 68. In the illustrated embodiment, the shape of both the interior cavity surface 82 and the skirt sealing surface 50 are generally cylindrical. In other embodiments, the interior cavity surface and skirt sealing surface can be other shapes.

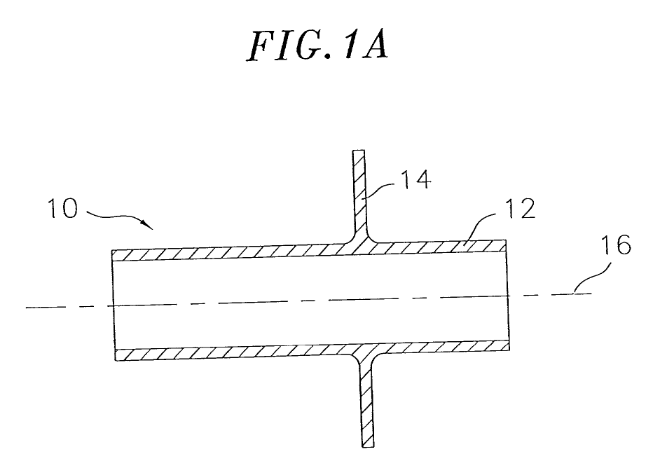

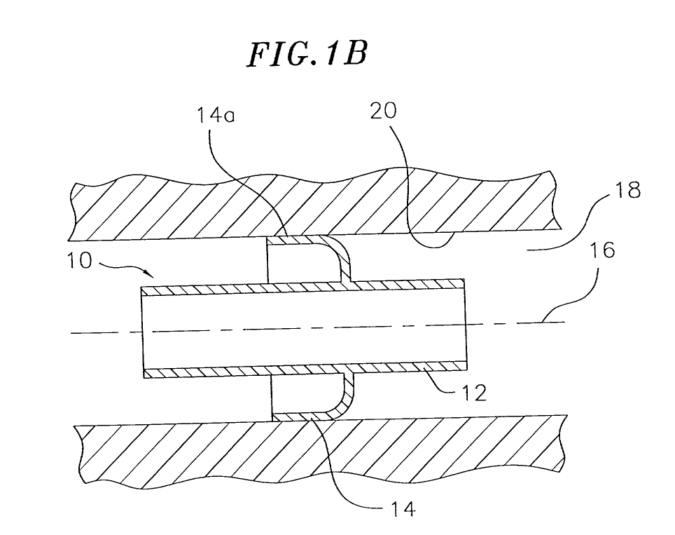

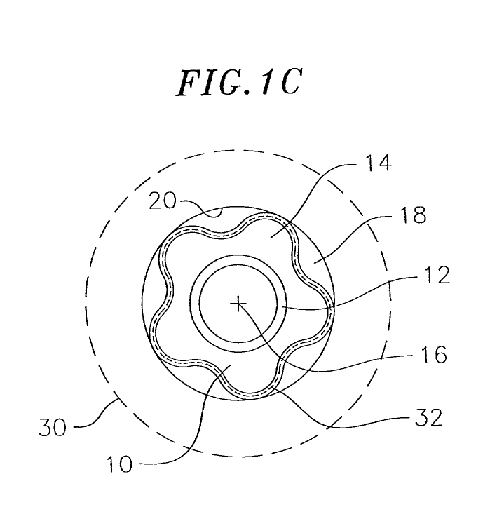

When the high pressure sealing assembly 40 is inserted into the cavity 68, the generally cylindrical skirt sealing surface 50 contacts the cavity interior surface 82 to thereby create a liquid and gas tight seal therebetween. Because the skirt 48 is preformed so that its sealing surface 50 has substantially the same shape as the interior cavity surface 82, the skirt must only deform a small amount to create a seal between the sealing surface 50 and the cavity surface 82. The amount of skirt deformation is small enough that the sealing surface 50 does not wrinkle in the manner illustrated in FIG. 1C. Therefore, no leak paths exist between the sealing surface 50 and the cavity interior surface 82.

In one preferred embodiment of the sealing assembly 40, the diameter of the wire 60 inserted into the sleeve 42 is 0.06 inches, the internal diameter of the sleeve is 0.06 inch, the diameter of the cavity 68 is 0.121 inch, the width of the skirt 48 is 0.012 inch and the length of the skirt sealing surface 50 is 0.0185 inch. If the skirt sealing surface 50 is shorter than this, then it will not create a seal. If the length of the skirt 48 increases it begins to curl when inserted. If a skirt 48 curls, then pressure variations can cause it to fail. In alternative embodiments, a seal was created when the length of the skirt sealing surface 50 was within the range 0.010-0.030 inch. In other embodiments of the sealing assembly, a seal can also be made between wires of different diameters and shapes and cavities of different diameters and shapes. An advantage of using a molded skirt is that other embodiments of the sealing assembly can achieve seals in applications where the cavity is not cylindrical.

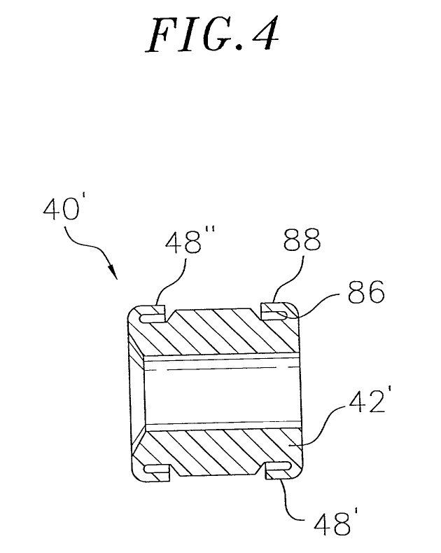

Turning now to FIG. 4, another preferred embodiment of a sealing assembly 40′ provided in accordance with practice of the present invention is illustrated. The sealing assembly 40′ comprises a sleeve 42′ with two molded flanges 48′ and 48″. The flanges 48′ and 48″ are integrally formed on the sleeve and are shaped similarly to the flange 48 of FIG. 2, having interior surfaces 86 and sealing surfaces 88. The sealing assembly 40′ is specifically adapted to provide a seal in circumstances where an exposed contact passes between two cavities. The sleeve 42′ is configured to surround an exposed contact. The first molded skirt 48′ seals the opening in a first cavity and the second molded skirt 48″ seals an opening in a second cavity. The molded skirts 48′ and 48″ are constructed from an elastic material similar to those that can be used in the construction of the sealing assembly 40 of FIG. 2. The sealing surfaces 88 of the skirts 48′ and 48″ have substantially the same shape as the interior surfaces of the cavities (not shown) in which the skirts are inserted. The sealing surfaces 88 create airtight seals where they contact the cavity interior surfaces.

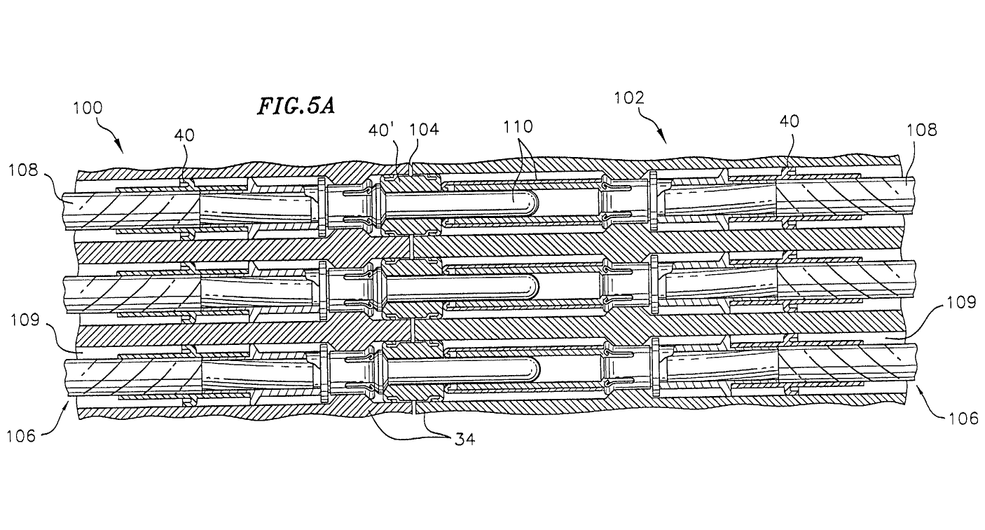

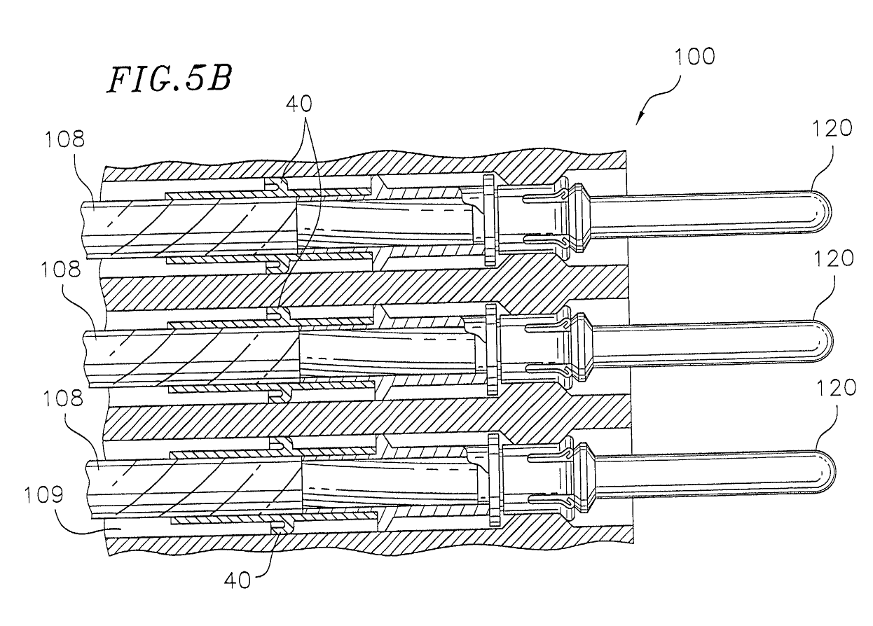

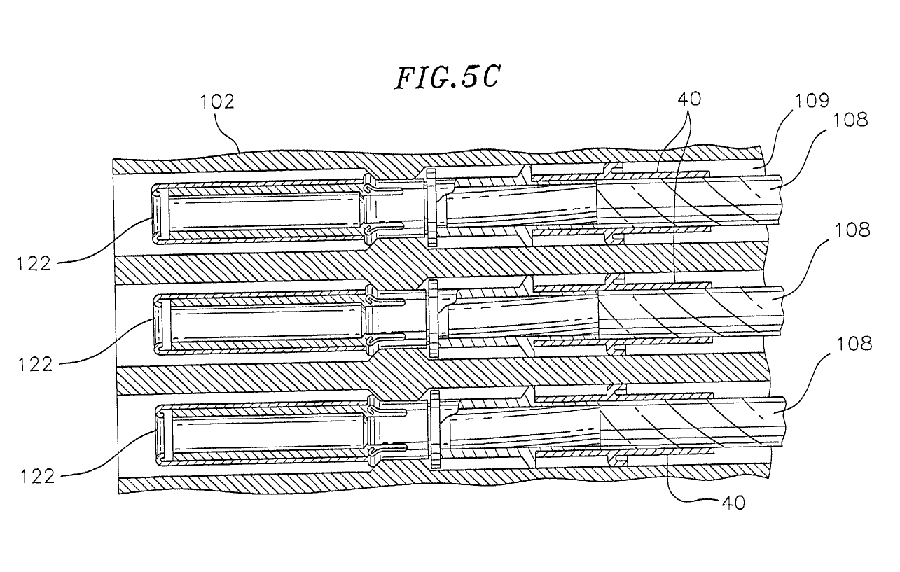

Turning now to FIG. 5A, the use of the sealing assembly 40 of FIG. 2 in conjunction with the sealing assembly 40′ of FIG. 4 to seal the electrical contacts inside an electrical connector is illustrated. Electrical connectors are typically constructed from two connector bodies 100 and 102. Each connector body 100 and 102 has a front face 104 and a back face 106. Wires 108 are fed into the connector bodies 100 and 102 through openings 109 in their back faces. Both connector bodies 100 and 102 contain contacts 110 and each wire 108 is connected to one of these contacts 110. Electrical connections between the wires 108 are established by aligning the front faces 104 of each of the connector bodies 100 and 102 so that the contacts 110 in one of the connector bodies 100 establish electrical connections with the contacts 110 in the other connector body 102. The sealing assemblies 40 and 40′ in accordance with practice of the present invention combine to completely seal the exposed wires and contacts from the external environment.

Turning now to FIGS. 5B and 5C in addition to FIG. 5A, the two connector bodies 100 and 102 are illustrated. The contacts in the first connector body 100 are pin contacts 120 and the contacts in the second connector body 102 are socket contacts 122. In such a configuration, the first connector body 100 is referred to as the pin connector body and the second connector body 102 is referred to as the socket connector body.

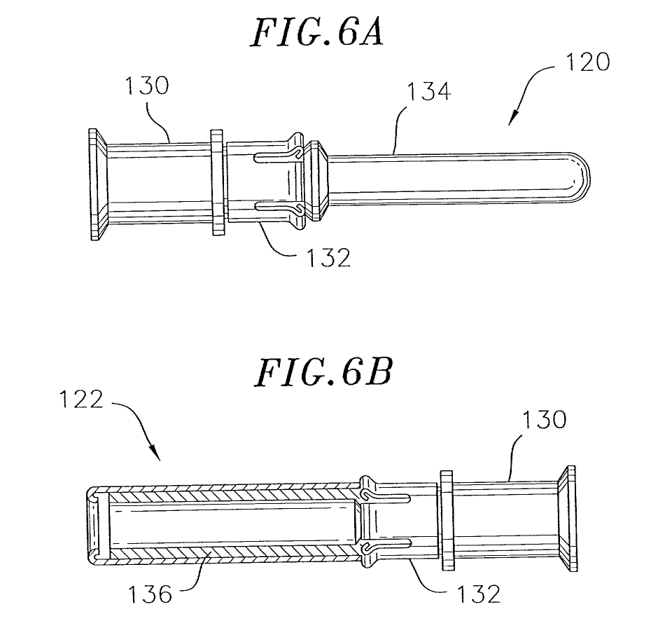

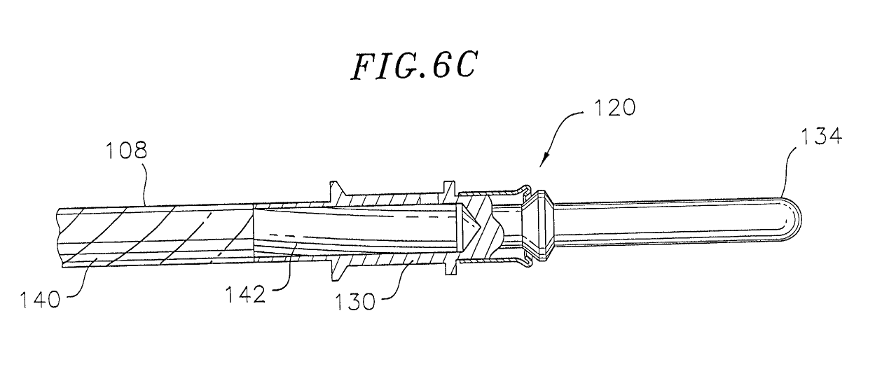

Turning now to FIGS. 6A and 6B a pin contact 120 and a socket contact 122 are illustrated. Both the pin contact and socket contact have wire receiving ends 130, contact retention clips 132 and contact ends 134 and 136. The contact ends are designed so that the pin contact end 134 can mate with the socket contact end 136 to establish an electrical connection.

Turning now to FIG. 6C in addition to FIGS. 6A and 6B, the insertion of a wire 108 into a pin contact is illustrated. A wire 108 is threaded into the wire receiving end 130 of the contact 120. The wire 108 is shielded from the environment using a layer of insulation 140. The portion of the wire 142 inside the wire receiving end 130 of the contact 120 is stripped of insulation to enable an electrical connection between the wire 108 and the contact 120. The wire 108 is fixed into the wire receiving end 130 by crimping. However, soldering or other suitable methods in which the electrical connection between the wire 108 and the contact 120 is preserved can also be used.

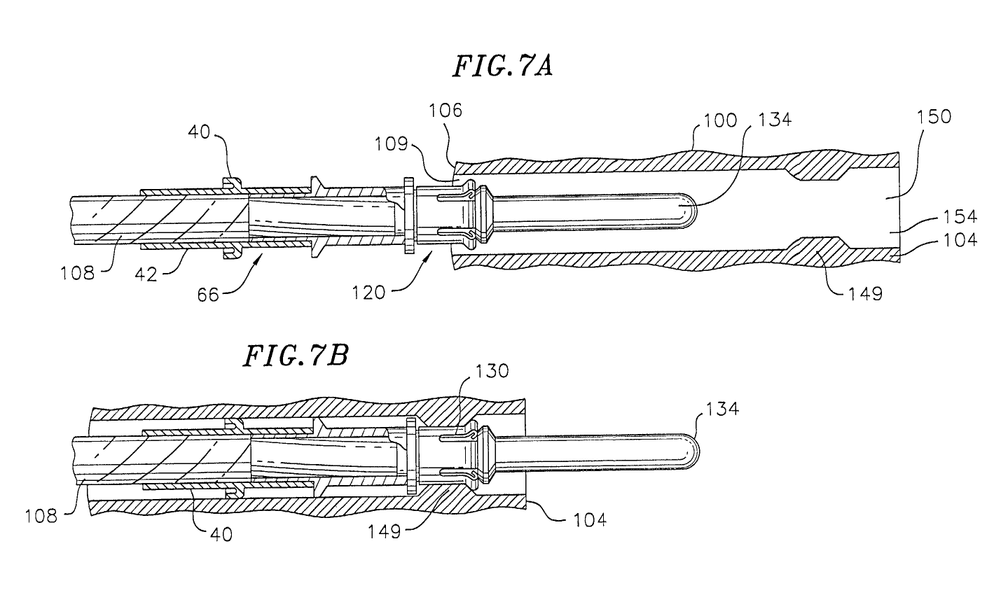

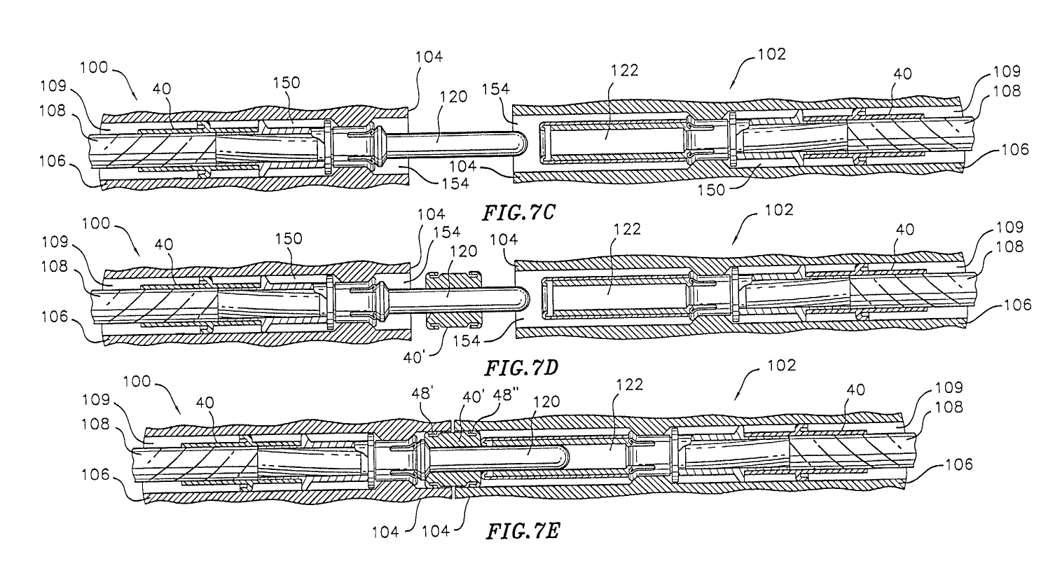

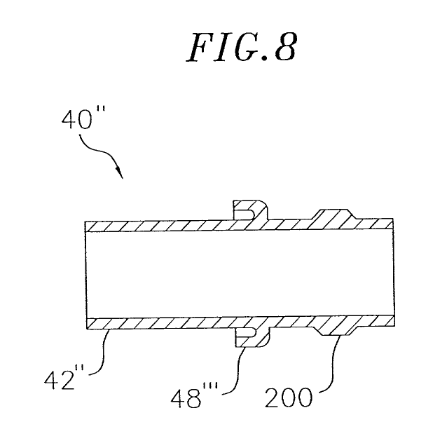

Turning now to FIGS. 7A-7E, the method of constructing an electrical connector including pin contacts and socket contacts and sealing the connector using embodiments of the sealing assembly provided in accordance with practice of the present invention is illustrated. Referring now to FIG. 7A, a pin contact 120 connected to a wire 108 with a sealing assembly 40 mounted on the wire are shown being inserted through an opening 109 into a cavity 150 including a molded in contact retention shoulder 149 in a connector body 100. The connector is constructed by threading the wire 108 into each of the contacts 120 as described above and then placing the sealing assembly 40 over the wire 108. The sealing assembly 40 is positioned so that its insertion end 66 is aligned towards the pin contact 120 and so that an insulated portion of the wire is contained within the sleeve 42. The wires 108 with pin contacts 120 are then inserted into the connector body 100 through the openings 154 in the back face 106 of the pin connector body. The wires 108 with socket contacts are inserted into the electrical connector 100 through the openings 109 in the back face 106 of the socket connector body 102. Each of the connector cavities 150 extend from an opening 109 in the back face 106 of the connector body to the opening 154 in its front face 104. Inserting the wire 108 into the cavity 150 through the opening 109 causes the sealing assembly 40 to seal the opening 109.

Referring now to FIG. 7B, a pin contact connected to a wire with a sealing assembly mounted on the wire inside a cavity in a pin connector body 100 is shown. The cavity contains a molded-in contact retention shoulder 149. Such contact retention shoulders are used to fix the wires 108 and their contacts inside the connector bodies 100 and 102. A contact retention clip 130 on the contact locks with the contact retention shoulder 149 to prevent movement of the wire 108 and its contact once it has been inserted into the cavity 150. The contact retention shoulder 149 is located so that the pin contact 134 protrudes from the front face 104 of the pin connector body 100. The contact retention shoulders in socket connector bodies (not shown) are recessed from the front face 104 of the connector body such that the socket contacts are slightly set back from the opening of the cavity in the front face of the socket connector body.

Referring now to FIGS. 7C-7E, the creation of a complete seal around the pin contact and socket contact using the sealing assemblies 40 and 40′ in accordance with practice of the present invention is illustrated. Referring first to FIG. 7C, the cavity openings 109 in the rear faces 106 of the connector bodies 100 and 102 are sealed using the sealing assembly 40

Referring now to FIG. 7D, the sealing assembly 40′ provided in accordance with practice of the present invention in the process of being mounted on the pin contact 120 is shown. The sealing assembly 40′ is used to seal the cavity openings 154 in the front faces 104 of the connector bodies 100 and 102. The sealing assembly 40′ is placed on the pin contact 120 and the front faces 104 of the connector bodies 100 and 102 are pushed together so that the pin contact 120 mates with the socket contact 122.

Referring now to FIG. 7E, the sealing assembly 40′ sealing the openings in the front faces 104 of the pin connector body and the socket connector body is illustrated. The molded flanges 48′ and 48″ are used to seal the cavities 154 in the front faces 104 of the connector bodies 100 and 102. The first molded flange 48′ of the sealing assembly 40′ is used to seal the gap between the pin contact 120 and the opening 154 in the front face 104 of the pin connector body 100 and the second molded flange 48″ seals the gap between the pin contact 120 and the opening 154 in the front face 104 of the socket connector body 102. In addition, the sealing assembly protects the portion of the pin contact 120 that extends from the cavity 154 in the pin connector body 100 to the cavity 154 in the socket connector body 102 from the environment. In combination, the sealing assemblies 40 and 40′ completely seal the uninsulated portion of the wires 108 and the contacts 120 and 122 from the external environment.

Turning now to FIG. 8, one preferred embodiment of the sealing assembly 40″ provided in accordance with practice of the present invention that includes a wiping land 200 is illustrated. The sealing assembly 40″ comprises a sleeve 42″, a molded skirt 48′″ and a wiping land 200. The wiping land 200 cleans a cavity surface (not shown) as the sealing assembly 40″ is being inserted into the cavity. This ensures that residues on the surface of the cavity do not create an uneven contact between the skirt 48′″ and the surface of the cavity, which can create a leak path.

The sealing assemblies 40, 40′ and 40″ are described above as being useful for creating complete environmental seals for mated pin and socket contacts housed in two connector bodies. However, the methods described above can be equally applied to seal electrical connectors that are constructed from a single connector body or from more than two connector bodies. The sealing assembly of the present invention can also be used to seal contacts other than the pin and socket contacts described above. The methods described above can be used whenever a seal is required between a cable and a cavity. Alternative embodiments of the sealing assembly can be used to seal gaps between optical fibers and cavities in optical connectors. The methods described above can also be used in any connector where a portion of an exposed conductor, optic cable or other type of cable extends between two sealed cavities. The methods described above can also be used in automotive applications. The fact that individual contacts can be sealed using different embodiments of the sealing assembly of the present invention also means that it can be used to seal the contacts in an electrical connector irrespective of the number of contacts in that connector.

While the above description contains many specific features of the invention, these should not be construed as limitations on the scope of the invention, but rather as an example of preferred embodiments thereof. Many other variations are possible. Accordingly, the scope of the invention should be determined not by the embodiments illustrated, but by the appended claims and their legal equivalents.

What is claimed is:

1. A device for sealing a cavity comprising an interior surface, said device comprising:
a sleeve;
a molded skirt integrally formed on said sleeve comprising an interior surface and a sealing surface;
wherein said sealing surface has substantially the same shape as the interior surface of the cavity such that the sealing surface is not substantially wrinkled when said sealing surface is in sealing contact with said interior surface of the cavity.

2. The device of claim 1, wherein:
said cavity comprises an opening; and
said sleeve and said molded skirt substantially prevent the movement of matter between the inside and the outside of said cavity through said opening.

3. The device of claim 2, wherein said sleeve and said molded skirt are constructed from elastomeric material.

4. The device of claim 1, further comprising:
a wiping land.

5. A device for sealing a cavity comprising an interior surface, said device comprising:
a sleeve comprising a longitudinal axis and an insertion end;
a molded skirt assembly integrally formed on said sleeve;
wherein said skirt assembly comprises a first integral section extending in a plane which is substantially perpendicular to said longitudinal axis; and
wherein said skirt assembly comprises a second integral section comprising an interior surface and a sealing surface that extends along the length of the sleeve in a direction opposite to said insertion end such that there is a gap between said interior surface and said sleeve.

6. The device of claim 5, wherein said sealing surface has substantially the same shape as the interior surface of said cavity.

7. The device of claim 6, further comprising:
a wiping land located between said molded skirt assembly and said sleeve insertion end.

8. The device of claim 5, wherein said device is constructed from elastomeric material.

9. A method of sealing an opening of a cavity comprising the steps of:
inserting a portion of a structure through a sleeve of a sealing assembly, said sealing assembly having a molded skirt;
inserting a section of said structure including portion of said structure inserted through said sealing assembly into said cavity through said cavity opening so that said molded skirt is in sealing contact with the inside surface of said cavity wherein said molded skirt comprises a sealing surface that has substantially the same shape as the interior surface of said cavity such that the sealing surface is not substantially wrinkled when said sealing surface is in sealing contact with said cavity interior surface.

10. The method of sealing an opening of a cavity of claim 9, wherein said sealing assembly also comprises a wiping land.

11. The method of sealing an opening of a cavity of claim 10, further comprising the step of:
cleaning a portion of interior surface of said cavity using said wiping land.
